(19) United States
(12) Patent Application Publication
(10) Pub. No.: US 2004/0144870 A1
(43) Pub. Date: Jul. 29, 2004

(54) Fuel injection device

(75) Inventors: Yasuhide Tani, Nogoya-city (JP); Kimitaka Saito, Nagoya-city (JP); Atsuya Okamoto, Okazaki-city (JP); Takashi Suzuki, Toyohashi-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Kariya-city (JP)

(21) Appl. No.: 10/736,900

(22) Filed: Dec. 17, 2003

(30) Foreign Application Priority Data
Dec. 17, 2002 (JP) 2002-364907
Nov. 14, 2003 (JP) 2003-385686

(51) Int. Cl. B05B 1/30

(52) U.S. Cl. 239/585.1

(57) ABSTRACT

In a fuel injection device, an injection bore plate has a first surface to which inlets of injection bores are opened and a second surface positioned on a side of a valve seat with respect to the first surface so that a step is formed between the first and second surfaces. The step serves to restrict fuel flow from the second surface so that the fuel is allowed to flow toward the injection bores in the first surface. Parallel flow of fuel causes to strengthen fuel stream and circular force is given to the fuel since the fuel hits against the step, which results in promoting atomization of fuel, even if each of the injection bores is formed simply in a column shape.

### CROSS REFERENCE TO RELATED APPLICATIONS

This application is based upon and claims the benefit of priority of Japanese Patent Applications No. 2002-364907 filed on Dec. 17, 2002, and No. 2003-385686 filed on Nov. 14, 2003, the contents of which are incorporated herein by reference.

### BACKGROUND OF THE INVENTION

1. Field of the Invention

The present invention relates to a fuel injection device for an internal combustion engine (hereinafter called “engine”).

2. Description of Related Art

When fuel is injected from a fuel injection device to an engine, it is important to atomize the fuel for a purpose of reducing harmful emission contained in exhaust gas or securing less fuel consumption. JP-A-2001-317431 discloses the fuel injection device in which fuel passing through a fuel passage formed by a valve body and a valve member is injected via a plurality of injection bores formed in an injection bore plate.

Each axis of the injection bores inclines in a plate thickness direction of the injection bore plate. Each of the injection bores is a taper shaped hole so that each inner diameter of the injection bores is smallest at a fuel inlet and larger toward a fuel outlet. Accordingly, formation of fuel film is progressed in each of the injection bores so that atomization of the fuel to be injected is promoted.

To further promote the atomization of the fuel, inventors of the present invention has taken it into consideration that fuel stream entering each of the injection bores is preferably a circular stream. However, if formation of the circular stream requires additional component or part, construction of the fuel injection device is prone to be complicated so that its manufacturing cost is higher.

### SUMMARY OF THE INVENTION

An object of the present invention is to provide a fuel injection device whose construction is simpler and in which fuel atomization is sufficiently promoted.

To achieve the above object, in a fuel injection device having a valve body, a valve member and an injection bore plate, the valve body has an inner wall in which a fuel passage is formed. The inner wall is provided with a valve seat. The valve member has a valve coming in contact with the valve seat. The valve member is operative to close the fuel passage when the valve is seated on the valve seat and to open the fuel passage when the valve leaves the valve seat. The injection bore plate is mounted on the valve body downstream the valve seat and is provided with a plurality of injection bores through which an end surface thereof on a side of the valve seat communicates with an end surface thereof on a side opposite to the valve seat and with a step formed on the end surface thereof on a side of the valve seat.

According to the device mentioned above, the step serves not only to guide fuel so as to flow into the injection bores from the fuel passage but also to strengthen stream of the fuel in a given direction before the fuel enters the injection bores. Accordingly, with a simpler construction, atomization of fuel is promoted.

It is preferable that the injection bore plate is provided at the end surface thereof on a side of the valve seat with a first surface to which inlets of the injection bores are opened and with a second surface positioned on a side of the valve seat with respect to the first surface so that the step is formed between the first and second surfaces. Accordingly, the step guides the fuel to flow into the injection bores through the first surface without passing through the second surface and the strengthened fuel streams are never weakened by the fuel flowing from the second surface.

It is preferable that a fuel inflow control member is disposed in the fuel passage on a side of the valve seat with respect to the injection bore plate for allowing fuel from the fuel passage to flow into the first surface.

Preferably, after the fuel enters the first surface and hits against the step, the fuel may flow into the injection bores. As an alternative, after the fuel flowing on the first surface constitutes two streams in opposite directions along the step and the two streams hit against each other, the fuel may flow into the injection bores.

When two fuel streams flow in the same direction, the fuel streams are strengthened and when the two fuel streams hit against the step or each other, circular forces are given to the fuels to be flowed into the injection holes.

Further, the injection bore plate may be provided with a plurality pieces of the first surfaces each having two injection bores and with a plurality pieces of the second surfaces, whereby the plurality of first and second surfaces are alternately arranged circumferentially so that the step is formed between each of the plurality of first surfaces and each of the plurality of second surfaces.

Furthermore, the injection bore plate may have a plurality of first surfaces circumferentially arranged so as to abut on one another in a vicinity of an axial center thereof, each of the first surfaces has a single piece of the injection bores and a plurality of second surfaces circumferentially arranged and each being sandwiched between the adjacent two of the first surfaces so that the steps are formed on both sides of each of the first surfaces.

### BRIEF DESCRIPTION OF THE DRAWINGS

Other features and advantages of the present invention will be appreciated, as well as methods of operation and the function of the related parts, from a study of the following detailed description, the appended claims, and the drawings, all of which form a part of this application. In the drawings:

FIG. 1 is a cross sectional view of an injector according to a first embodiment;

FIG. 2 is a schematic perspective view of a bottom of an injection bore plate of the injector according to the first embodiment;

FIG. 3 is a schematic exploded perspective view of a control plate and the bottom of the injection bore plate of the injector according to the first embodiment;

FIG. 4 is a schematic cross sectional view of the control plate and the bottom of the injection bore plate of the injector according to the first embodiment;

FIG. 5 is a schematic view of the bottom of the injection bore plate of the injector as viewed from a side of the control plate according to the first embodiment;

FIG. 6 is a schematic view of a bottom of an injection bore plate of an injector as viewed from a side of a control plate according to a second embodiment of the present invention;

FIG. 7 is a schematic exploded perspective view of the control plate and the bottom of the injection bore plate of the injector according to the second embodiment;

FIG. 8 is a schematic view of a bottom of an injection bore plate of an injector as viewed from a side of a control plate according to a third embodiment of the present invention;

FIG. 9 is a schematic view of a bottom of an injection bore plate of an injector as viewed from a side of a control plate according to a modification of the third embodiment;

FIG. 10 is a schematic view of a bottom of an injection bore plate of an injector as viewed from a side of a control plate according to a fourth embodiment of the present invention;

FIG. 11 is a schematic exploded perspective view of the control plate and the bottom of the injection bore plate of the injector according to the fourth embodiment;

FIG. 12 is a schematic view of a bottom of an injection bore plate of an injector as viewed from a side of a control plate according to a modification of the fourth embodiment;

FIG. 13 is a schematic view of a bottom of an injection bore plate of an injector as viewed from a side of a control plate according to a fifth embodiment of the present invention;

FIG. 14 is a schematic exploded perspective view of the control plate and the bottom of the injection bore plate of the injector according to the fifth embodiment;

FIG. 15 is a schematic view of a bottom of an injection bore plate of an injector as viewed from a side of a control plate according to a sixth embodiment of the present invention;

FIG. 16 is a schematic exploded perspective view of the control plate and the bottom of the injection bore plate of the injector according to the sixth embodiment;

FIG. 17 is a schematic view of a bottom of an injection bore plate of an injector as viewed from a side of a control plate according to a modification of the sixth embodiment;

FIG. 18 is a schematic cross sectional view of a main part of an injector according to a seventh embodiment of the present invention;

FIG. 19 is a schematic exploded perspective view of main components of the injector according to the seventh embodiment;

FIG. 20A is a schematic view of the main components of the injector as viewed from a side of a valve body according to the seventh embodiment;

FIG. 20B is a cross sectional view taken along a line XXB-XXB of FIG. 20A;

FIG. 20C is a cross sectional view taken along a line XXC-XXC of FIG. 20A;

FIG. 21 is a schematic view showing a guide passage on the main components of the injector according to the seventh embodiment;

FIG. 22 is a schematic cross sectional view of a main part of an injector according to an eighth embodiment of the present invention;

FIG. 23 is a schematic perspective view of a needle and a control member of the injector according to the eighth embodiment (when the needle leaves the control member);

FIG. 24 is another schematic perspective view of the needle and the control member of the injector according to the eighth embodiment (when the needle comes in contact with the control member); and

FIG. 25 is a schematic view showing a guide passage on the control member of the injector according to the eighth embodiment.

### DETAILED DESCRIPTION OF THE PREFERRED EMBODIMENTS

Embodiments of the present invention are described with reference to drawings.

### First Embodiment

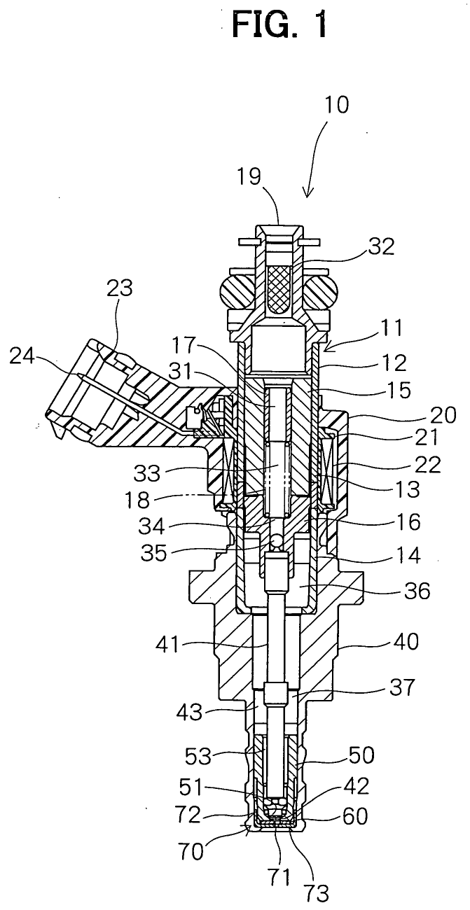

As shown in FIG. 1, a fuel injection device 10 (injector 10) according to a first embodiment may be applied, for example, to a direct injection type gasoline engine or a preliminary mixture type gasoline engine. The injector 10 is mounted on an engine head (not shown) in the direct injection type gasoline engine and on an intake pipe (not shown) in the preliminary mixture type gasoline engine.

A housing 11 of the injector 10 is formed in shape of a cylinder. The housing 11 is provided coaxially with a first magnetic portion 12, a non-magnetic portion 13 and a second magnetic portion 14. The non-magnetic portion 13 serves not to make a magnetic short circuit between the first and second magnetic portions 12 and 14. A fixed core 15 is made of magnetic material and formed in cylindrical shape. The fixed core 15 is fixed coaxially to an inner circumferential wall of the housing 11. A movable core 16, which is made of magnetic material and formed in cylindrical shape, is slidably and reciprocatingly accommodated within the inner circumferential wall of the housing 11.

A spool 21 is mounted on an outer circumferential wall of the housing 11. A coil 22 is wound on the spool 21. Outer circumferences of the spool 21 and the coil 22 are covered with a resin mold 20. The coil 22 is electrically connected with a terminal 24 embedded in a connector 23 integrally formed with the resin mold 20. When current is supplied to the coil 22 through the terminal 24, a magnetic attracting force generates between the fixed core 15 and the movable core 16.

An adjusting pipe 17 is press fitted to an inner circumference of the fixed core 15. The adjusting pipe 17 is provided in an interior thereof with a fuel passage 31. An end of a spring 18 is in contact with an end of the adjusting pipe 17 on a side of the movable core 16. Another end of the spring 18 is in contact with the movable core 16. The spring 18 urges the movable core 16 in a direction opposite to the fixed core 15. A biasing force of the spring 18 for urging the movable core 16 is adjusted by changing an inserting distance of the adjusting pipe 17 into the fixed core 15 for press fitting.

The housing 11 has a fuel inlet 19 to which fuel is supplied from a fuel tank(not shown). Fuel entered from the fuel inlet 19 flows via a filter 32 to an interior of the housing 11. The filter 32 serves to eliminate foreign material mixed in the fuel.

A nozzle holder 40, formed in cylindrical shape, is connected to an end of the housing 11. A valve body 50 is fixed to an inner circumferential wall of the nozzle holder 40. The valve body 50 is formed in cylindrical shape and fixed to the nozzle holder 40, for example, by press fitting or welding. The valve body 50 is provided in an inner circumferential wall thereof with a conical valve seat face 51 whose inner diameter is smaller toward a front end thereof. A control plate 60 and an injection bore plate 70, which serve as a fuel inflow control means, are sandwiched between the nozzle holder 40 and an end of the valve body 50 on a side opposite to the housing 11. A plurality of injection bores 71 are formed in the injection bore plate 70.

A nozzle needle 41 as a valve is accommodated in interiors of the housing 11, the nozzle holder 40 and the valve body 50 so as to move axially and reciprocatingly therein. An end of the nozzle needle 41 is connected to the movable core 16 so that the nozzle needle 41 may move axially and reciprocatingly together with the movable core 16. The nozzle needle 14 is provided at another end thereof on a side opposite to the movable core 16 with a contact portion 42. A fuel passage 53 is formed between the nozzle needle 41 and the valve body 50.

Fuel flowed in from the fuel inlet 19 to the interior of the housing 11 flows to a fuel passage 33 formed in an interior of the movable core 16 via the filter 32, the fuel passage formed in the interior of the adjusting pipe 17 and the fuel passage 33 formed in the interior of the fixed core 15. The fuel in the fuel passage 34 flows to a fuel passage 36 formed between housing 11 and the nozzle needle 41 via a fuel aperture 35 through which the interior of the movable core 16 communicates with an exterior thereof. The fuel in the fuel passage 36 further flows to the fuel passage 53 formed between the valve body 50 and the nozzle needle 41 via a fuel passage 37 formed between the nozzle holder 40 and the nozzle needle 41.

When current is not supplied to the coil 22, nozzle needle 41 together with movable core 16 is urged downward in FIG. 1 by the biasing force of the spring 18 so that the contact portion 42 is seated on the valve seat face 51. Accordingly, fuel flow from the fuel passage 53 to the injection bores 71 is interrupted and the fuel is not injected.

When current is supplied to the coil 22, the magnetic attracting force generates between the fixed core 15 and the movable core 16. Accordingly, the movable core 16 and the nozzle needle 41 integrated with the movable core 16 are moved upward in FIG. 1, that is, toward the fixed core 15, against the biasing force of the spring 18. The contact portion 42 leaves the valve seat face 51, which allows fuel flow from the fuel passage 53 to the injection bores 71. The fuel passing through a clearance between the contact portion 42 and the valve seat face 51 is injected from the injection bores 71 formed in the injection bore plate 70.

Upon de-energizing the coil 22, the magnetic attracting force between the fixed core 15 and the movable core 16 disappears so that the movable core 16 and the nozzle needle 41 integrated with the movable core 16 are moved downward in FIG. 1 by the biasing force of the spring 18. Accordingly, the-contact portion 42 is seated again on the valve seat face 51 and the fuel flow from the fuel passage 53 to the injection bores 71 is interrupted, resulting in terminating the fuel injection.

Details of the injection bore plate 70 and parts in vicinity thereof are described next.

The injection bore plate 70 is positioned at a front end of the valve body 50 on a side opposite to the housing 11. The control plate 60, which serves to orient a flow direction of fuel flowing into the injection bore plate 70, are disposed between the injection bore plate 70 and the valve body 50. The injection bore plate 70 is formed in shape of a cylinder having a cylindrical wall 72 and a bottom 73. The cylindrical wall 72 is radially sandwiched between an outer circumferential wall of the valve body 50 and an inner circumferential wall of the nozzle holder 40. The bottom 73 is axially sandwiched between an outer bottom wall of the valve body 50 and an inner bottom wall of the nozzle holder 40.

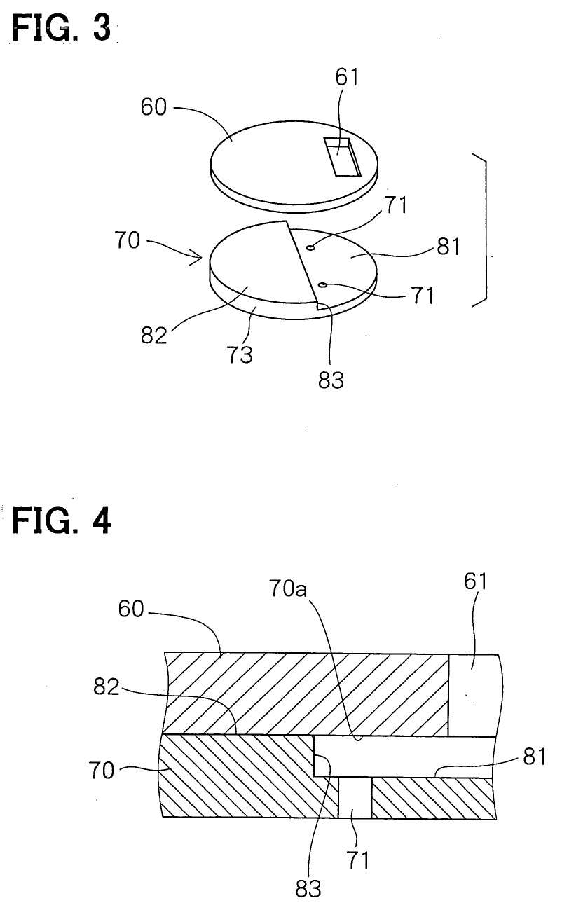

The control plate 60 and the injection bore plate 70 are stacked on top of each other, as shown in FIGS. 3 and 4. The cylindrical wall 72 of the injection bore plate 70 shown in FIG. 3 is omitted. The control plate 60 is provided with a control hole 61 through which fuel passes from the valve body 50 to the injection bore plate 70.

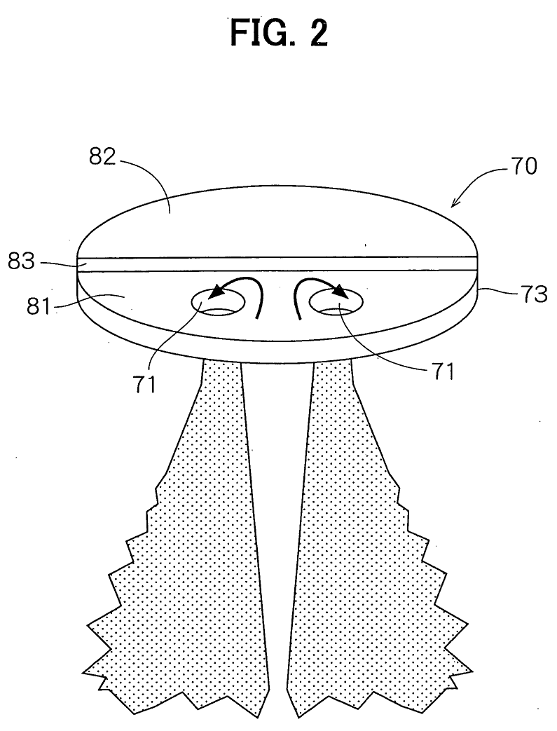

The injection bore plate 70 is provided at the bottom 73 thereof with a first surface 81 and a second surface 82, as shown in FIGS. 2, 3 and 4. Fuel inlets of the injection bores 71 are opened to the first surface 81. The second surface 82 is positioned on a side of the valve body 50 with respect to the first surface 81. That is, the first and second surfaces 81 and 82 are formed stepwise so that a step 83 exists between the first and second surfaces 81 and 82.

As shown in FIG. 4, due to the formation of the step 83, the second surface 82 comes in contact with a surface 70a of the control plate 60 on a side of the injection bore plate 70 and a gap is formed between the first surface 82 and the surface 70a of the control plate 60 on a side of the injection bore plate 70. Accordingly, fuel passing through the control hole 61 of the control plate 60 flows into the first surface 81, not into the second surface 82. Due to the formation of the step 83, fuel flow from the first surface 81 into the injection bores 71 is allowed but fuel flow from the second surface 82 into the injection bores 71 is restricted.

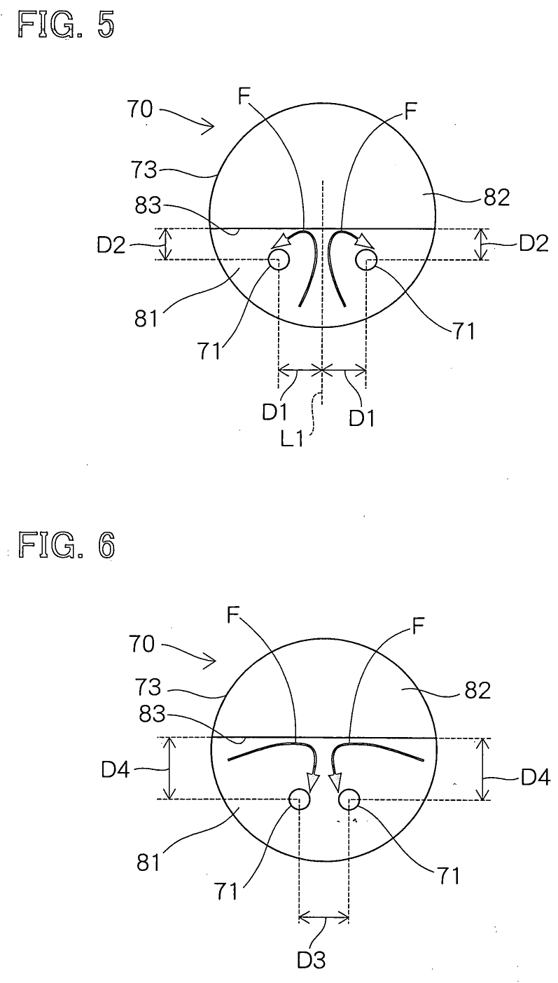

As shown in FIG. 2, two pieces of injection bores 71 are formed in the first surface 81. Each of the injection bores 71 is formed in shape of a column whose inner diameter is substantially uniform from the fuel inlet to the fuel outlet. An axis of the injection bore 71 may be formed in parallel with or obliquely to an axis of the injection bore plate 70. As shown in FIG. 5, a hypothetical line L1, which is positioned midway between two injection bores 71, that is, from any point of which axial centers of the two injection bores 71 are at equal distances, crosses substantially perpendicularly to the step 83. Assuming that a distance from each axial center of the two injection bores 71 to the hypothetical line L1 is D1 and a distance from the each axial center of the two injection bores 71 to the step 83 is D2, if the distance is measured on the first surface 81 to which each fuel inlet of the two injection bores is opened, a formulas, D1>D2, is satisfied.

As shown in FIGS. 3 and 4, the control hole 61 formed in the control plate 60 allows the fuel to flow into the first surface 81. Since the step 83 is formed in the injection bore plate 70, the gap is formed between the first surface 81 and the control plate 60 and the second surface 82 is in contact with the control plate 60, as mentioned above. As shown in FIG. 4, the control hole 61 of the control plate 60 is opened to a position facing to the first surface 81 of the injection bore plate 70. The fuel passing through the control hole 61 of the control plate 60 flows into the first surface 81 without flowing into the second surface 82. As shown in FIG. 3, the control hole 61 of the control plate 60 is opened to a position near an outer circumference of the bottom 73 so that the fuel flowed into the first surface 81 flows toward the step 83 along the hypothetical line L1.

Since the injection bores 71 and the step 83 are positioned to satisfy D1>D2, the fuel flowed into the first surface 81 of the injection bore plate 70 flows as larger fuel streams along the hypothetical line L1 between the two injection bores 71 as shown by arrows F in FIG. 5. The respective fuel streams between the two injection bores 71 and on both sides of the hypothetical line L1 are oriented in the same directions toward the step 83 so that the fuel streams may be strengthened. The fuels, whose streams have been strengthened, hit against the step 83 so that the fuels are turned back toward the injection bores 71 and flow into the injection bores 71. Accordingly, the stream of fuel flowing into each of the injection bores 72 not only strengthens but also receives a circular (swirl) force.

Further, since the step 83 is formed in the injection bore plate 70 so that fuel flow from the second surface 82 to the injection bores 71 is suppressed, the fuel stream strengthened on the first surface 81 is never weakened at each fuel inlet of the injection bores 71 by the fuel flow from the second surface 82. Accordingly, the fuel, which flowed into the injection bore 71 in a state that stream of the fuel has been strengthened and the circular force has been given to the fuel, is injected from each fuel outlet of the injection bores 71 after a stronger circular stream has been formed inside the injection bore 71.

According to the first embodiment, the stream of fuel is strengthened and the circular force is given to the fuel before the fuel flows into the injection bore 71 so that formation of the stronger circular stream is enhanced inside the injection bore 71, resulting in promoting atomization of the fuel. Since the stream of fuel is further strengthened at the fuel inlet of the injection bore 71, strong circular stream is formed, even if pressure of the fuel is relatively low, so that better atomization of the fuel may be secured. As mentioned above, since the step 83 is formed in the injection bore plate 70 so that the atomization of fuel is promoted, any other components for producing the circular force is necessary. Accordingly, the injector whose structure is simpler is composed of less number of component parts so that the injector may be manufactured at lower cost.

According to the first embodiment, the distance D1 from the axial center of the injection bore 71 to the hypothetical line L1 is larger than the distance D2 from the axial center of the injection bore 71 to the step 83. Accordingly, the fuel flowed into the first surface 81 flows as larger fuel streams between the two injection bores 71 along the theoretical line L1 and hits against the step 38 substantially perpendicular to the theoretical line L1. Since the fuel streams on both sides of the theoretical line L1 are orientated in the same directions so that the fuel streams strengthen each other. Further, since the fuel hits substantially perpendicularly against the step 83, kinetic energy that the fuel has is effectively converted to circular force energy so that formation of the circular stream inside the injection bore 71 is enhanced, resulting in promoting the atomization of the fuel.

According to the first embodiment, since the atomization of fuel to be injected from each of the injection bores 71 is promoted, the fuel can be atomized in a desired shape or pattern without increasing the number of the injection bores 71. For increasing the number of the injection bores 71, more complicated processes and more time for manufacturing the injection bores 17 are required. Further, since each of the injection bores 71 is formed in shape of an column, formation of the injection bores 71 can be easily achieved through a simpler manufacturing processes and at less manufacturing time so that the injector may be effectively manufactured.

### Second Embodiment

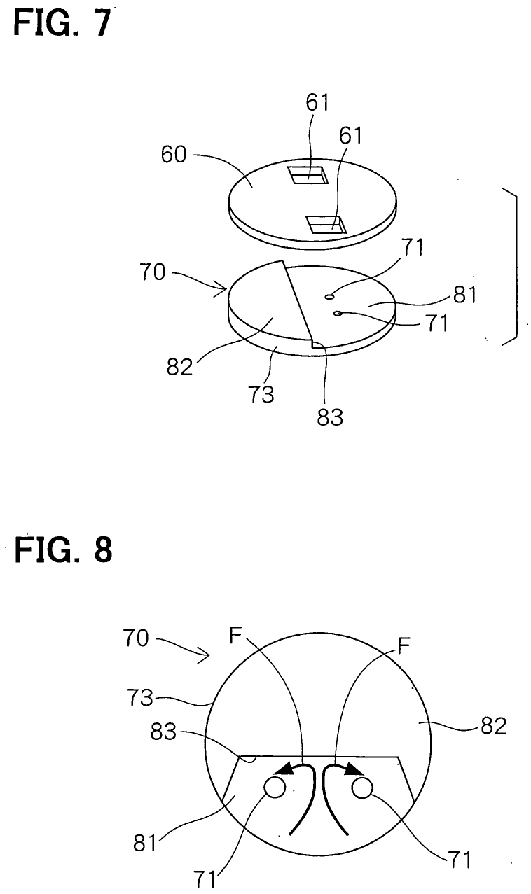

An injection bore plate according to a second embodiment is described with reference to FIGS. 6 and 7. The same reference number as the first embodiment is assigned to a substantially similar component and its explanation is omitted.

As shown in FIG. 6, a position relationship between the injection bores 71 and the step 83 according to the second embodiment is different from that according to the first embodiment. According to the second embodiment, assuming that a distance between axial centers of the two injection bores 71 is D3 and a distance from each axial center of the two injection bores to the step 83 is D4, a formulas, D3<D4, is satisfied. That is, the distance from each axial center of the two injection bores to the step 83 is larger than the distance between axial centers of the two injection bores 71. As shown in FIG. 7, the control plate 60 has two control holes 61 formed at positions facing to the first surface 81 near radially opposite ends of the injection bore plate 70.

Since D3<D4 is satisfied, fuel flows as a larger fuel stream between each of the injection bores 71 and the step 83 as shown by arrows F in FIG. 6. Respective fuels flowed into the first surface 81 at positions near radially opposite ends of the injection bore plate 70 flow toward a center of the injection bore plate 70 along the step 83. The fuel flowed in from one of the radially opposite ends of the injection bore plate 70 hits against the fuel flowed in from the other thereof at the center of the injection bore plate 70 so that respective fuel streams are turned perpendicularly to directions in which the respective fuel flowed toward the center of the injection bore plate 70. The respective fuels from the radially opposite ends of the injection bore plate 70 flow in the same directions after hitting against each other and being turned away from and substantially perpendicularly to the step 83, which results in strengthening the fuel streams. Accordingly, a circular force is given to the fuel flowing into each of the injection bores 71 whose fuel stream is strengthened.

Since the step 83 serves to suppress the fuel flow from the first surface 81 to the second surface 82, the fuel stream strengthened on the first surface 81 is never weakened at each fuel inlet of the injection bores 71 by the fuel flow from the second surface 82. Accordingly, the fuel, which flowed into the injection bore 71 in a state that stream of the fuel has been strengthened and the circular force has been given to the fuel, is injected from a fuel outlet of the injection bore 71 after a stronger circular stream have been formed inside the injection bore 71.

According to the second embodiment, the respective fuels flow into the first surface 81 substantially in parallel with and along the step 83 from the radially opposite ends of the injection bore plate 70. In this case, the fuel streams are strengthened and the circular force is given to the fuels before the fuels flow into the injection bores 71 so that formation of the strong circular stream is enhanced inside the injection bores 71, resulting in promoting atomization of the fuel, similarly as the first embodiment.

According to the second embodiment, the fuel streams from the radially opposite ends of the injection bore plate 70 hit against each other about at the center of the injection bore plate 70 so that the fuel streams are orientated in the same directions, resulting in strengthening the fuel streams each other. Further, since the fuel streams hit against each other, kinetic energy that the fuel has is effectively converted to circular force energy so that formation of the circular stream inside the injection bore 71 is enhanced, resulting in promoting the atomization of the fuel.

### Third Embodiment

An injection bore plate according to a third embodiment is described with reference to FIG. 8. The same reference number as the first embodiment is assigned to a substantially similar component and its explanation is omitted.

As shown in FIG. 8, according to the third embodiment, the second surface 82 is formed to surround the first surface 81. A position relationship between each of the injection bores 71 and the step 83 is similar as the first embodiment so that a distance between the two injection bores 71 is longer by more than twice than a distance between each of the two injection bores 71 and the step 83. A direction in which fuel flows in through the control plate 60 is similar as the first embodiment. With this structure, fuel stream is strengthened as shown by arrows F in FIG. 8, and circular force is given to the fuel, similarly as the first embodiment, so that atomization of the fuel is promoted.

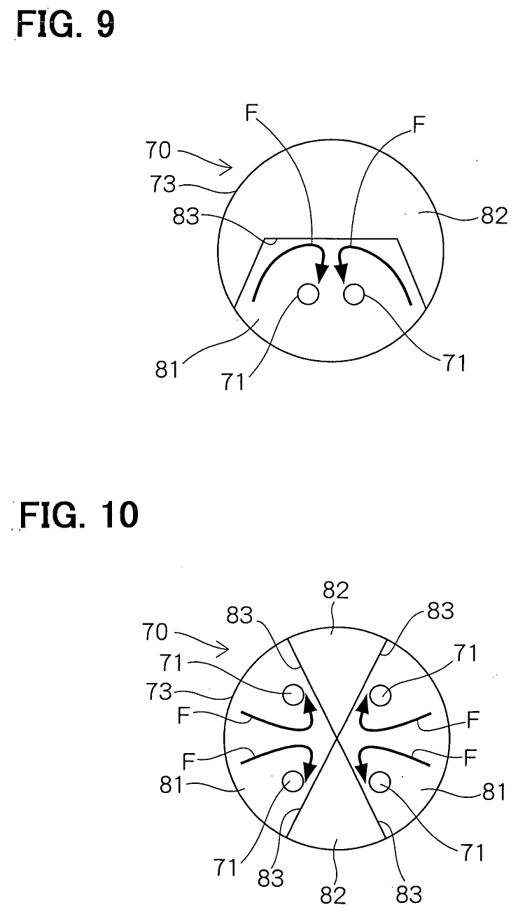

As shown in FIG. 9, the thirst embodiment may be modified in such a manner that the distance between each of the two injection bores 71 and the step 83 is longer than the distance between the two injection bores 71. In this case, two streams of fuel flowed into the first surface 81 along the step 83 enter each of the injection bores 71, similarly as the second embodiment, after having hit against each other about in a center of the injection bore plate 70, as shown in arrows F in FIG. 9. Accordingly, fuel stream is strengthened and circular force is given to the fuel, similarly as the second embodiment, so that atomization of the fuel is promoted.

### Fourth Embodiment

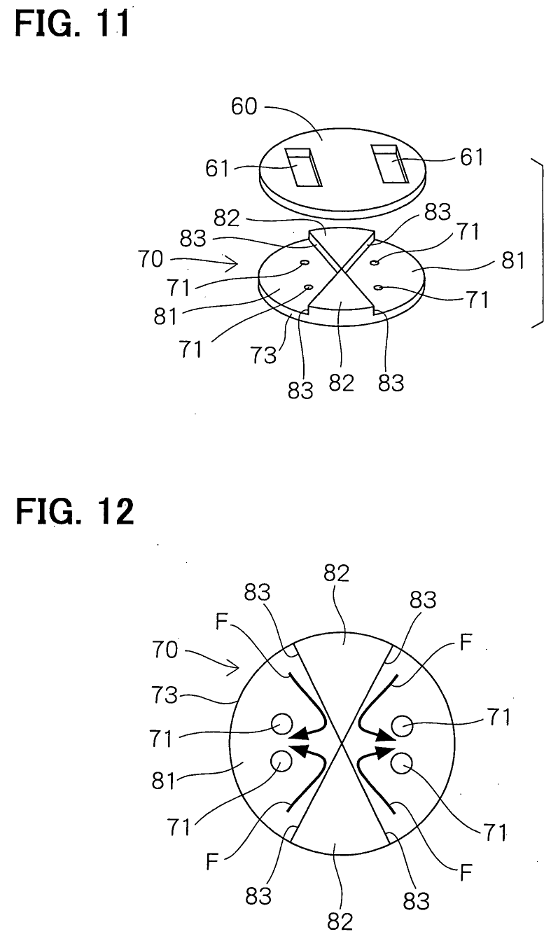

An injection bore plate according to a fourth embodiment is described with reference to FIGS. 10 and 11. The same reference number as the first embodiment is assigned to a substantially similar component and its explanation is omitted.

According to the fourth embodiment, as shown in FIG. 10, two pieces of the first surfaces 81, to each of which the fuel inlets of the injection bores 71 are opened and which are formed in the injection bore plate 70, are circumferentially spaced so that two pieces of the second surfaces 82 are positioned between the two pieces of the first surfaces 81, respectively. A total number of the injection bores 71 formed in the injection bore plate 70 is four. A position relationship between each of the injection bores 71 and the step 83 is similar as the first embodiment so that a distance between the two injection bores 71 is longer by more than twice than a distance between each of the two injection bores 71 and the step 83. As shown in FIG. 11, two control holes 61 of the control plate 60 are formed so as to correspond to the respective first surfaces 81 of the injection bore plate 70 so that fuel passing through the control plate 60 enters as larger fuel stream between the two injection bores formed in the respective first surfaces 81 and, after having hit against the step 83, the fuel streams turned back, as shown by arrows F in FIG. 11. Accordingly, the fuel stream is strengthened and circular force is given to the fuel, similarly as the first embodiment, so that atomization of the fuel is promoted.

As shown in FIG. 12, the fourth embodiment may be modified in such a manner that the distance between each of the two injection bores 71 and the step 83 is longer than the distance between the two injection bores 71. In this case, two streams of fuel flowed into the first surface 81 along the step 83 enter each of the injection bores 71, similarly as the second embodiment, after having hit against each other about in a center of the injection bore plate 70, as shown in arrows F in FIG. 9. Accordingly, the fuel stream is strengthened and circular force is given to the fuel, similarly as the second embodiment, so that atomization of the fuel is promoted.

Further, as four pieces of the injection bores 71 are formed in the injection bore plate 70, the fourth embodiment has a further advantage due to increase of the number of the injection bores 71 so that atomization of the fuel is further promoted.

### Fifth Embodiment

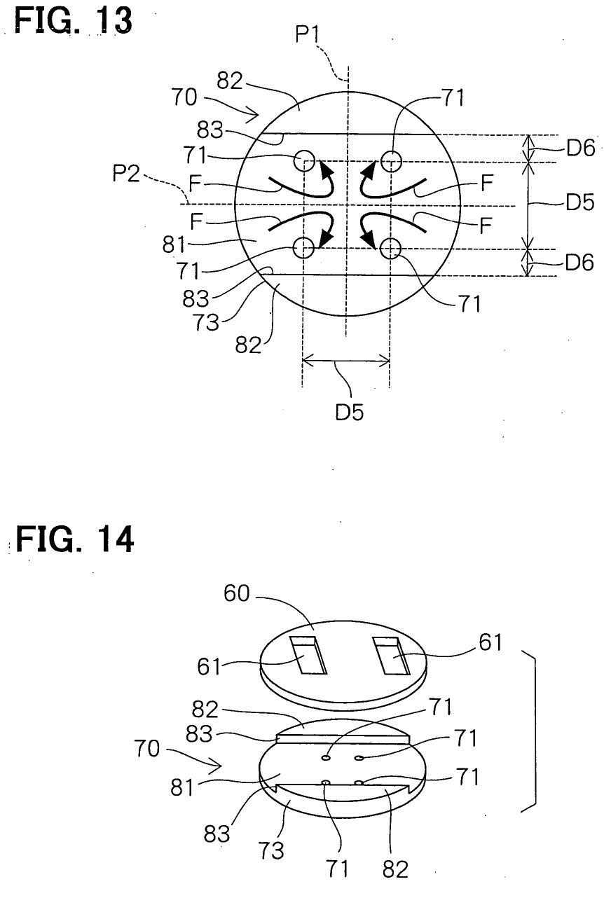

An injection bore plate according to a fifth embodiment is described with reference to FIGS. 13 and 14. The same reference number as the first embodiment is assigned to a substantially similar component and its explanation is omitted.

According to the fifth embodiment, as shown in FIG. 13, the first surface 81 is formed substantially in shape of an oval. The first surface 81 is defined by two straight circumferential lines spaced in direction of the first axis P1 (first radial direction) and two arc shaped circumferential lines spaced in direction of a second axis P2 (second radial direction) perpendicular to the first axis P1. Distance between the two arc shaped circumferential lines in direction of the second axis P2 is longer than distance between the two straight circumferential lines in direction of the first axis P1. The second surfaces 82 are formed outside opposite ends of the first surface 81 in direction of the first axis P1 so as to extend outward in opposite directions of the first axis P1 from the respective two straight circumferential lines. The steps 83 are formed at opposite ends of the first surface 81 in direction of the first axis P1 and each of the steps 83 extends perpendicularly to the first and second surfaces 81 and 82.

The injection bore plate 70 is provided with four injection bores 71 whose axial centers are positioned substantially on the same circular line, that is, on four apexes of a square, respectively. Each fuel inlet of the four injection bores 71 is opened to the first surface 81. Distance D5 between axial centers of adjacent injection bores 71 in direction of the first axis P1 is longer than distance D6 between each axial center of the injection bores 71 and each of the steps 83 (D5>D6). As shown in FIG. 14, the control plate 60 is provided at positions in vicinity of opposite ends of the first surface 81 in direction of the second axis P2 with the control holes 61 from which fuel is flowed into the first surface 81. The axial centers of the four injection bores 71 may be positioned not only on the four apexes of the square but also on four apexes of a rectangular, respectively.

As shown by arrows F in FIG. 13, fuel stream passing through the control plate 60 at an end of the first surface 81 in direction of the second axis P2 enter into a fuel passage between the two adjacent injection bores 71 arranged in direction of the first axis P1. On the other hand, another fuel stream passing through the control plate 60 at another end of the first surface 81 in direction of the second axis P2 enter into a fuel passage between the two adjacent injection bores 71 arranged in direction of the first axis P1. The fuel streams entered from opposite directions along the second axis P2 hit against each other about in a center of the injection bore plate 70 so that each of the fuel streams is turned back perpendicularly to the direction in which the fuel stream entered the first surface 81. After having hit against each other, the fuel streams are oriented substantially in the same direction, that is, in direction of the first axis P1, between the each of the injection bores 71 so that the fuel streams are strengthened, as shown by arrows FIG. 13. Then, the integrated fuel streams hit against the step 83 so that the fuel streams are again turned back and separated into two fuel streams in opposite directions along the step 83. Accordingly, fuel stream entering each of the injection bores 71 is strengthened and circular force is given to the fuel, resulting in promoting the atomization of the fuel, similarly as the second embodiment.

Further, since the step 83 is formed in the injection bore plate 70 so that fuel flow from the second surface 82 to the injection bores 71 is suppressed, the fuel stream strengthened on the first surface 81 is never weakened at each fuel inlet of the injection bores 71 by the fuel flow from the second surface 82.

Furthermore, as four pieces of the injection bores 71 are formed in the injection bore plate 70, the fifth embodiment has a further advantage due to increase of the number of the injection bores 71 so that atomization of the fuel is further promoted.

### Sixth Embodiment

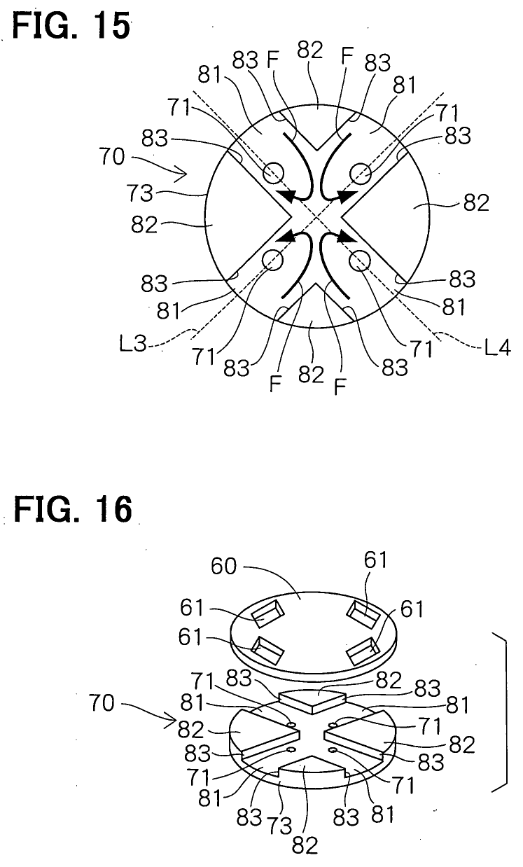

An injection bore plate according to a sixth embodiment is described with reference to FIGS. 15 and 16. The same reference number as the first embodiment is assigned to a substantially similar component and its explanation is omitted.

According to the sixth embodiment, as shown in FIG. 15, the injection bore plate 70 is provided with four pieces of first surfaces 81 each having a single piece of the injection bore 70. The four first surfaces 81 abut on one another in a vicinity of an axial center of the injection bore plate 70 so that an entire shape of the four first surfaces 81 is roughly a cross whose center passes through the axial center of the injection bore plate 70. Four pieces of second surfaces 82 are circumferentially spaced and each of the second surfaces 82 is formed between adjacent first surfaces 81 so that the steps 83 are formed on both sides of each of the first surfaces 81. Four injection bores 71 are arranged on a circle concentric with the injection bore plate 70 and each fuel inlet of the injection bores 71 is opened to each of the first surfaces 81. Hypothetical lines L3 and L4 constitute a cross and each of the hypothetical lines L3 and L4 is a line connecting centers of two pieces of the injection bores 71 radially opposed to each other through the axial center of the injection bore plate 70. Each longitudinal center line of the four first surfaces 81 is offset from the hypothetical line L3 or L4 so that, in each of the first surfaces 81, distance between the center of the injection bore 71 and one of the steps 83 is different from a distance between the center of the injection bore 71 and the other of the steps 83. Accordingly, in each of the first surfaces 81, a fuel path on a side of the hypothetical line L3 or L4 with respect to each of the injection bores 71a constitute a wider fuel path. As shown in FIG. 16, the control plate 60 is provided at positions corresponding to the respective first surfaces 81 with control holes 61 through which fuel enter into the respective first surfaces 81.

After each fuel flows into each of the first surfaces 81 via the control plate 60, the fuel flows through the wider fuel path of each of the first surfaces 81 along the step 83 toward the axial center of the injection bore plate 70. A fuel stream in one of the first surfaces 81 merges with a fuel stream in another of the first surfaces 81 adjacent thereto so that both of the fuel streams flow substantially in the same direction and constitute a combined fuel stream, which results in strengthening the respective fuel streams. Then, the combined fuel stream formed by fuel streams in adjacent two of the first surfaces 81 hits against another combined fuel stream formed by fuel streams in another adjacent two of the first surfaces 81 radially opposed to the former two of the first surfaces 81 so that each of the fuel stream in each of the first surfaces 81 is turned back and enters each of the injection bores 71. The fuel stream entering each of the injection bores 71 is strengthened and circular force is given to the fuel, resulting in promoting the atomization of the fuel.

Further, since the steps 83 are formed in the injection bore plate 70 so that fuel flow from the second surfaces 82 to the injection bores 71 is suppressed, the fuel streams strengthened on the first surface 81 are never weakened at fuel inlets of the injection bores 71 by the fuel flow from the second surfaces 82.

Furthermore, as four pieces of the injection bores 71 are formed in the injection bore plate 70, the sixth embodiment has a further advantage due to increase of the number of the injection bores 71 so that atomization of the fuel is further promoted.

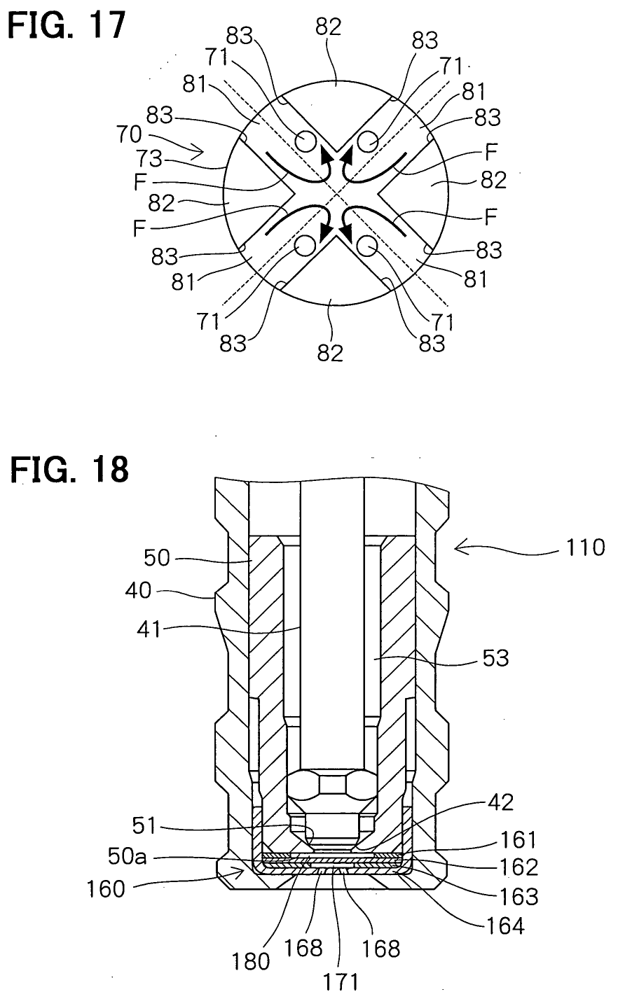

As shown in FIG. 17, the fifth embodiment may be modified in such a manner that the longitudinal center lines of the first surfaces 81 radially opposed to each other is on a straight line passing through the axial center of the injection bore plate 70 and each center of the injection bores 71 is offset from each of the longitudinal center lines of the first surfaces 81. Accordingly, in each of the first surfaces 81, distance between the center of the injection bore 71 and one of the steps 83 is different from a distance between the center of the injection bore 71 and the other of the steps 83. In this case, fuel stream in each of the first surfaces 81 hits against one another in a vicinity of the axial center of the injection bore plate 70, as shown by arrows F in FIG. 17. Therefore, the fuel stream entering each of the injection bores 71 is strengthened and circular force is given to the fuel, resulting in promoting the atomization of the fuel.

### Seventh Embodiment

An injector 110 according to a seventh embodiment is described with reference to FIGS. 18 to 21. The same reference number as the first embodiment is assigned to a substantially similar component and its explanation is omitted.

As shown in FIG. 18, the injector 110 is provided at a front end of a valve body 50 with a circular stream formation member 160. The circular stream formation member 160 is composed of an injection bore member and a guide member and serves to give a circular force to fuel. The circular stream formation member 160 has a first plate 161, a second plate 162, a third plate 163 and an injection bore plate 164 which are stacked on top of one another. The first plate 161 is positioned on a side of the valve body 50. The first and second plates 161 and 162 constitute the guide member and the third and injection bore plates 163 and 164 constitute the injection bore member.

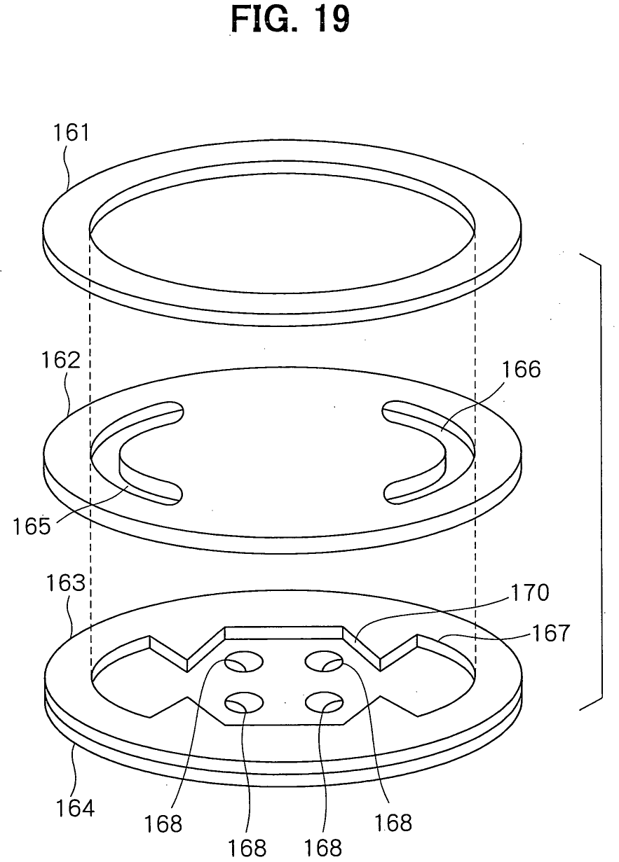

As shown in FIG. 19, the first plate 161 is a disk plate formed in shape of a ring. Inner diameter of the first plate 161 is larger than inner diameter of a fuel outlet of the valve body 50, that is, inner diameter of an end of the valve body 50 on a side of the first plate 161, as shown in FIG. 18. The injection bore plate 164 is formed in shape of a cylinder having a cylindrical wall and a bottom. The cylindrical wall of the injection bore plate 164 is radially sandwiched between an outer circumferential wall of the valve body 50 and an inner circumferential wall of a nozzle holder 40. The bottom of the injection bore plate 164 is axially sandwiched between an outer bottom wall of the valve body 50 and an inner bottom wall of the nozzle holder 40. However, in FIG. 19, the cylindrical wall of the injection bore plate 164 is omitted and the injection bore plate 164 is shown as a disk, similarly as the first to third plates 161 to 163 each of which is a disk plate, for a purpose of brevity of explanation.

As shown in FIG. 19, the second plate 162 has a pair of arc shaped openings 165 and 166. The openings 165 and 166 are arranged on a circle concentric with a center of the second plate 162. Each of the openings 165 and 166 is a through-hole penetrating the second plate 162 in thickness direction thereof. Each outer diameter of the openings 165 and 166 is substantially same as the inner diameter of the first plate 161.

The third plate 163 has a control opening 167 penetrating in thickness direction thereof. The control opening 167 is composed of a pair of near fan shaped openings positioned at opposite ends thereof and an octagonal opening positioned in a center thereof and sandwiched between the pair of fan shaped openings.

The injection bore plate 164 has four pieces of injection bores 168 in a vicinity of a center thereof. Each of the injection bores 168 penetrates in thickness direction of the injection bore plate 164 so that an end surface of the injection bore plate 164 on a side of the third plate 163 communicates with an end surface of the injection bore plate 164 on a side opposite to the valve body 50 through the injection bores 168. The third plate 163 is stacked on the injection bore plate 164 so that a circumferential wall forming the control opening 166 constitutes a step 170. Height of the step 170 corresponds to plate thickness of the third plate 163.

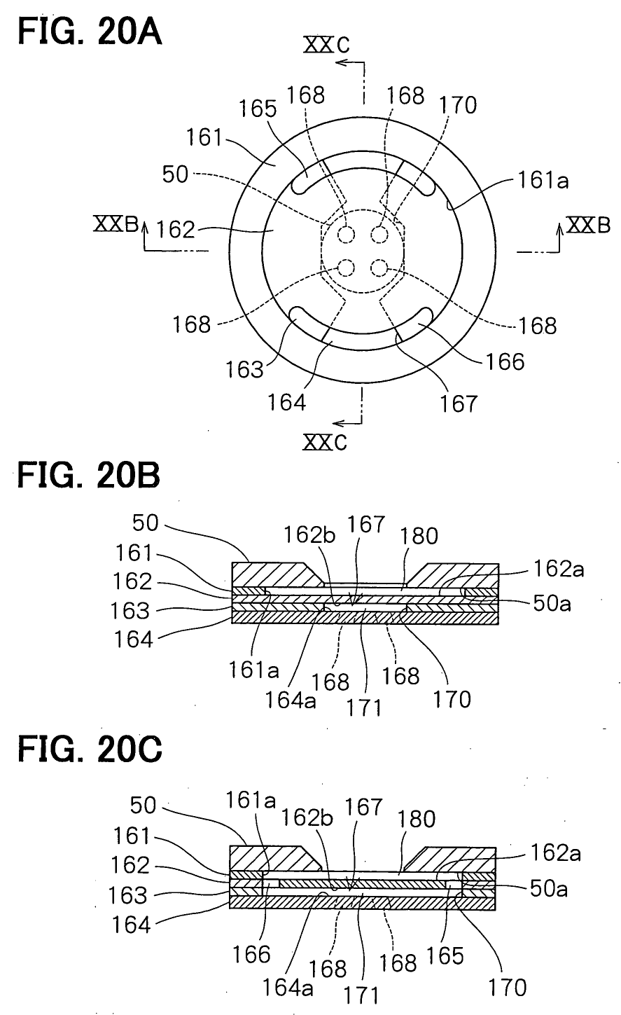

The first to third plates and the injection bore plate 161 to 164, which are stacked on top of one another, are installed at the end of the valve body 50. As shown in FIGS. 20A to 20C, an end surface 50a of the valve body 50 on a side of the first plate 161, an end surface 162a of the second plate 162 on a side of the first plate 161 and an inner circumferential surface 161a of the first plate 161 form a space 180, that is, the space 180 is formed by the valve body 50 and the guide member. The space 180 is formed substantially in shape of a column, since the first plate 161 is a ring shaped disk. Inner diameter of the space 180 is larger than the inner diameter of the outlet end of the valve body 50, since the inner diameter of the first plate 161 is larger than that of the outlet end of the valve body 50. The inner circumferential surface 161a of the first plate 161 forming the space 180, that is, an outer periphery of the space 180, is positioned radially outside the injection bores 168 formed in the injection bore plate 164. Radially opposite ends of the space 180 communicate with the openings 165 and 166 of the second plate 162.

The third plate 163 is sandwiched between the second and injection bore palates 162 and 164. An end surface 162b of the second plate 162 on a side of the third plate 163, an end surface 164a of the injection bore plate 164 on a side of the third plate 163 and the circumferential wall of the third plate forming the step 170 constitute a guide passage 171. As the control opening 167 of the third plate 163 is formed to extend radially, the guide passage extends radially. Radially opposite ends of the guide passage 171 communicates with the openings 165 and 166 of the second plate 162 and a center of the guide passage 171 communicates with the injection bores 168 opened to the injection bore plate 164 in a vicinity of the center thereof.

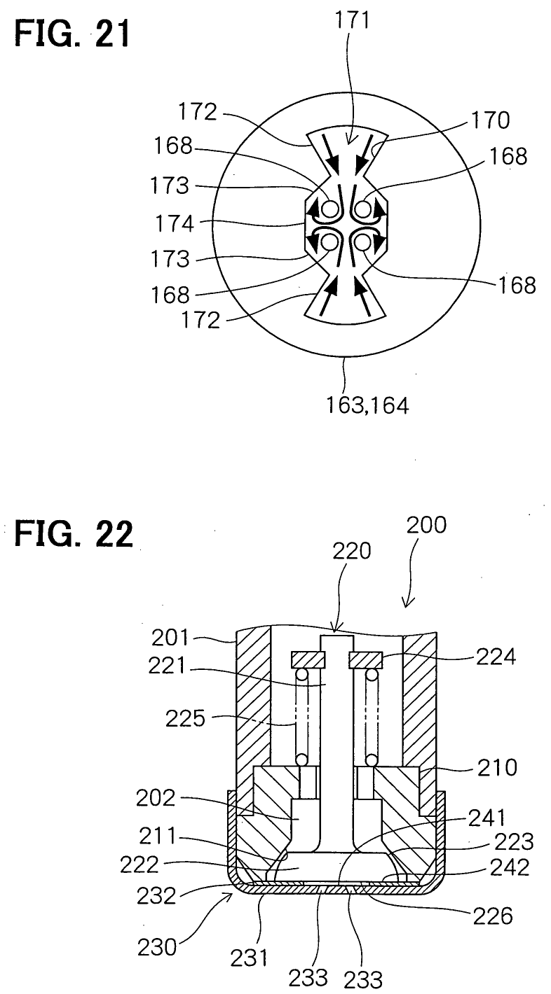

As shown in FIG. 21, since the control opening 167 of the third plate 163 is composed of the pair of near fan shaped openings and the octagonal opening, a cross sectional area of the guide passage 171 is gradually reduced radially inward and, then, gradually enlarged radially inward. The guide passage 171 has a pair of reducing area portions 172 each of which is formed in a fan shape and whose each cross sectional area is gradually smaller radially inward, a pair of enlarging area portions 173 each of which is connected to a radial inner end of the reducing area portion 172 and whose each cross sectional area is gradually larger radially inward and a uniform area portion 174 whose cross sectional area is constant radially. The injection bore 168 on a side of a fuel inlet thereof is opened to the uniform area portion 174. A distance between each center of the injection bores 168 and the step 170 in the enlarging area portion 173 is gradually longer radially inward, that is, toward the axial center of the injection bore plate 164.

How fuel flows is described next.

As shown in FIG. 18, when a nozzle needle 41 moves upward in the drawing and a contact portion 42 leaves a valve seat 51, fuel in a fuel passage 53 flows into the space 180 along an inner wall of the valve body 50. Since the inner diameter of the space 180 is larger than the inner diameter of the end of the valve body 50, as mentioned above, fuel flowed into the space 180 flows radially outward under guide of the end surface 162a of the second plate 162 and the end surface 50a of the valve body 50 both of which form the space 180. As the radially opposite ends of the space 180 communicates with the openings 165 and 166 of the second plate 162, the fuel flowed radially outward flow into the openings 165 and 166, respectively.

Then, the fuel flows into the guide passage 171 through the openings 165 and 166. Since the openings 165 and 166 communicate with the radially opposite ends of the guide passage 171, respectively, the fuel flows into the guide passage 171 from the radially opposite ends thereof. The fuel flows radially inward along the step 170 of the reducing area portion 172. Since the reducing area portion 172 is formed in a fan shape, the fuel constitutes a fuel stream converged on and toward the axial center of the injection bore plate 164. Fuel stream in the center thereof is swifter. That is, the fuel stream toward the axial center of the injection bore plate 164 is strengthened through the reducing area portion 172 of the guide passage 171.

After passing through the reducing area portion 172, the fuel flows radially inward along the step 170 of the enlarging area portion 173 and flows toward each of the injection bores 168. As the distance between each center of the injection bores 168 and the step 170 is longer gradually and the cross sectional area of the guide passage 171 is gradually expanding in the enlarging area portion 173, the fuel flowed in from one of the reducing area portions 172 to one of the enlarging area portions 173 hits fuel flowed in from the other of the reducing area portions 172 to the other of the enlarging area portions 173 so that the fuel circulates around each fuel inlet of the injection bores 168, as shown by arrows F in FIG. 21 and, then, enters each of the injection bores 168.

As mentioned above, according to the seventh embodiment, the stream of fuel flowing along the step 170 in the guide passage 171 is strengthened in the reducing area portion 172 and rapidly expanded in the enlarging area portion 173, which help to circulate the fuel around the fuel inlet of the injection bore 168. Accordingly, the atomization of fuel is promoted with a relatively simple structure.

According to the seventh embodiment, the distance between each of the injection bores 168 and the step 170 in the uniform area portion 174 is sufficiently long so that the uniform area portion 174 has a space sufficiently large to circulate or swirl the fuel, which also helps to form the circular fuel stream.

In the seventh embodiment, the first, second, third and injection bore plates 161, 162, 163 and 164 are formed separately and, then, stacked on top of one another. However, after the first and second plates 161 and 162 is formed into a first integrated body constituting the guide member and the third and injection bore plates 163 and 164 is formed into a second integrated body, the first and second integrated bodies may be stacked on top of each other. Further, all or any two or three components of the first, second, third and injection bore plates 161, 162, 163 and 164 may be integrally formed into a single piece and assembled with the component or components not integrally formed into the single piece.

### Eighth Embodiment

An injector 200 according to an eighth embodiment is described with reference to FIGS. 22 to 25.

As shown in FIG. 22, the injector 200 is provided with a valve body 210, a nozzle needle 220 and a control member 230. The valve body 210 is fixed to an end of a housing 201, for example, by welding. The valve body 210 is provided at inner wall thereof with a valve seat 211. The nozzle needle has a shaft 221 and a base 222 which are integrally formed into a single piece. The base 222 has a contact portion 223 which can be seated on the valve seat 211. The nozzle needle 220 is provided on the shaft 221 on a side opposite to the base 222 with a retaining portion 224. The retaining portion 224 is fixed to the nozzle needle 220. A coil spring 225 as a biasing means is disposed between the retaining portion 224 and the valve body 219. Instead of the coil spring 225, any biasing means such as a plate spring may be applicable, if the biasing means gives a pressing force. The coil spring 225, whose one end abuts on the retaining portion 224 and whose another end abuts on the valve body, produces an force in its expansion direction. The coil spring 225 urges the nozzle needle 220 upward in FIG. 22 via the retaining portion 224. Accordingly, when any force except the biasing force of the coil spring 225 is not applied to the nozzle needle 220, the contact portion 223 of the nozzle needle 220 is seated on the valve seat 211 of the valve body 210. An end of the base 222 on a side opposite to the shaft 221 has a flat surface 226.

The control member 230 is composed of a cup member 231 formed in a cup shape and a pair of fuel passage formation members 232. The cup member 231 and the fuel passage formation members 232 are connected with each other, for example, by welding. To form the control member 230, each of the fuel passage formation members 232 may be stacked on the cup member 231 without welding or formed integrally into a single piece. The fuel passage formation members 232 are positioned on radially opposite ends of the cup member 231 so as to be sandwiched between the valve body 210 and the cup member 231. The cup member 231 is provided in a vicinity of a center thereof with a plurality of injection bores 233 through which an end surface of the cup member 231 on a side of the valve body 210 communicates with another end surface of the cup member 231 on a side opposite to the valve body 210. The end surface of the cup member 231 on a side of the valve body 210, to which the injection bores on a side of fuel inlets thereof are opened, constitute a first surface 241.

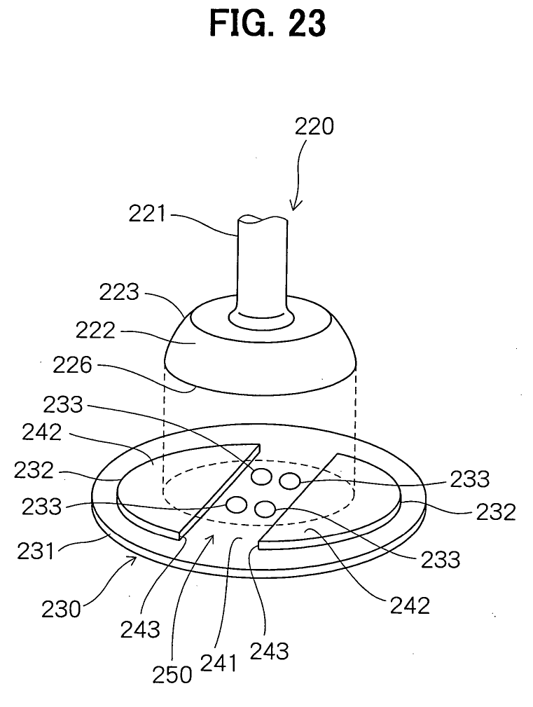

The fuel passage formation members 232 are positioned on a side of the valve body 210 with respect to the cup member 231. As shown in FIG. 23, each of the fuel passage formation members 232 is a plate formed in a bow shape. Each end surface of the fuel passage formation members 232 facing to the valve body 210 is a second surface 242 positioned on a side of the valve body 210 with respect the first surface 241 formed at the end surface of the cup member 231 on a side of the valve body 210. Since a step 243 is formed between the first surface and each of the second surfaces 241 and 242, the first surface 241 is sandwiched between a pair of the steps 243 substantially in parallel with each other so that the first surface 241 is formed substantially in shape of an elongated circle. The flat surface 226 at the end of the base 222 of the nozzle needle 220 can come in contact with the second surfaces 242. When the flat surface 226 comes in contact with the second surfaces 242, a guide passage 250 surrounded by the first surface 141, the pair of steps 243 and the flat surface 226 is formed.

As shown in FIG. 22, a fuel passage 202 is formed by the valve body 210 and the base 222 of the nozzle needle 220. When fuel is supplied to the fuel passage 202, the base 222 of-the nozzle needle 220 receives pressure force of the fuel acting downward in FIG. 22. When the pressure force of the fuel acting downward in FIG. 22 exceeds a biasing force of the coil spring 225 urging the nozzle needle 220 upward in FIG. 22, the nozzle needle 220 moves downward in FIG. 22 so that contact portion 223 leaves the valve seat 211. Axial moving of the nozzle needle 220 is stopped when the flat surface 226 of the nozzle needle 220 comes in contact with the second surfaces 242.

Fuel flow is described next.

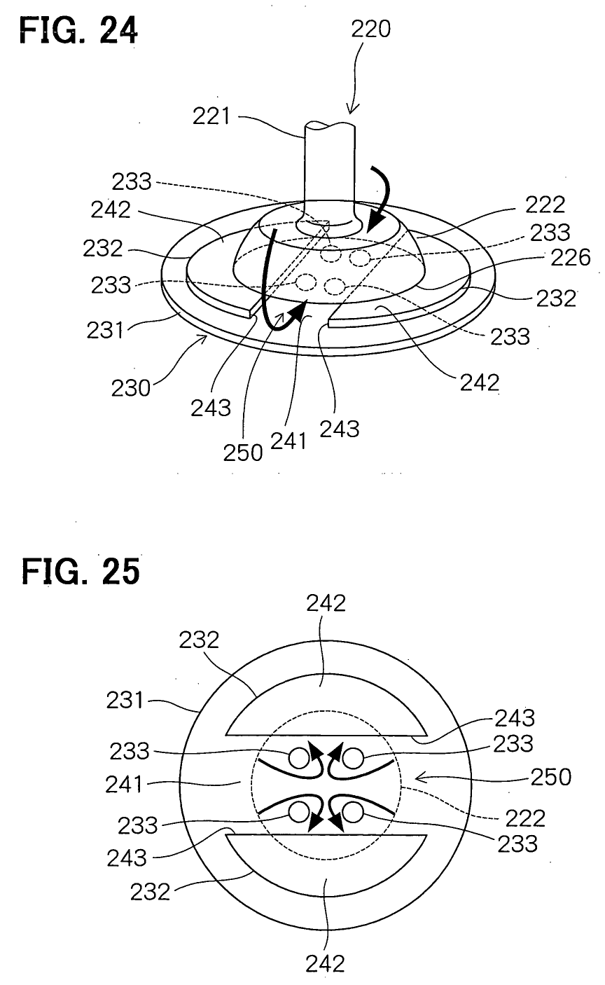

When a valve (not shown) installed in the injector 200 is opened and fuel is supplied to the fuel passage 202, the nozzle needle 220 moves downward in FIG. 22 due to the pressure force of fuel to be applied thereto. Thus, the contact portion 223 leaves the valve seat 211 so that the fuel in the fuel passage 202 flows toward the injection bores 233. At this time, since the flat surface 226 of the nozzle needle 220 comes in contact with the second surfaces 242, a space, whose height is equal to height of the step 243, is formed between the flat surface 226 of the nozzle needle 222 and the first surface 241 to which the inlets of the injection bores 233 are opened. As a result, as shown in FIG. 24, the fuel passing through a gap between the contact portion 223 and the valve seat 211 is guided to an outer circumference of the base 222 of the nozzle needle 220 before flowing into the injection bores 233 opened to about a center of the cup member 231.

Since an outer diameter of the base 222 of the nozzle needle 220 is smaller than that of the fuel passage formation member 232 232, radial opposite ends of the guide passage 250 are opened to positions radially outside the base 222, when the base 222 comes in contact with second surfaces 242. Accordingly, the fuel guided to the outer circumference of the base 222 flows into the guide passage 250 at the radially opposite ends thereof and flows along the steps toward the center of the cup member 231. As a result, as shown in FIG. 25, fuel streams from the radially opposite ends of the cup member 231 hit against each other at the center of the cup member 231 so that circular forces are given to the fuels before entering the injection bores 233, resulting in promoting atomization of fuel.

In the eight embodiment, instead of moving the nozzle needle 220 due to the pressure force of fuel applied thereto, the nozzle needle 220 may be driven by any other force such as an electromagnetic force.

In the embodiments mentioned above, the injector may be applied not only to the gasoline engine but also to the diesel engine. Further, instead of forming the injection bore in shape of a column whose diameter is uniform from the inlet thereof toward the outlet thereof, the injection bore may be formed in shape of a tapered column whose diameter is smaller or larger from the inlet thereof toward the outlet thereof.

Furthermore, a piece number of the injection bores is not limited to two or four but may be any number decide by an operation characteristic of the engine.

What is claimed is:

1. A fuel injection device comprising:
a valve body having an inner wall in which a fuel passage is formed, the inner wall being provided with a valve seat;
a valve member having a valve coming in contact with the valve seat, the valve member being operative to close the fuel passage when the valve is seated on the valve seat and to open the fuel passage when the valve leaves the valve seat; and
an injection bore plate mounted on the valve body downstream the valve seat, the injection bore plate being provided with a plurality of injection bores through which an end surface thereof on a side of the valve seat communicates with an end surface thereof on a side opposite to the valve seat and with a step formed on the end surface thereof on a side of the valve seat,
wherein the step serves not only to guide fuel so as to flow into the injection bores from the fuel passage but also to strengthen stream of the fuel in a given direction before the fuel enters the injection bores.

2. The fuel injection device according to claim 1, wherein the injection bore plate is provided at the end surface thereof on a side of the valve seat with a first surface to which inlets of the injection bores are opened and with a second surface positioned on a side of the valve seat with respect to the first surface so that the step is formed between the first and second surfaces, whereby the step causes the fuel to flow into the injection bores through the first surface without passing through the second surface.

3. The fuel injection device according to claim 2, wherein, after the fuel enters the first surface and hits against the step, the fuel flows into the injection bores.

4. The fuel injection device according to claim 2, wherein, after the fuel flowing on the first surface constitutes two streams in opposite directions along the step and the two streams hit against each other, the fuel flows into the injection bores.

5. The fuel injection device according to claim 3, wherein the injection bore plate has two injection bores and, further, wherein, after the fuel flows on the first surface toward the step along a hypothetical line from any point of which axial centers of the two injection bores are at equal distances and hits against the step, a stream the fuel is turned back and split into two streams each oriented toward each of the two injection bores.

6. The fuel injection device according to claim 5, wherein a distance from each axial center of the two injection bores to the hypothetical line is larger than a distance from the each axial center of the two injection bores to the step.

7. The fuel injection device according to claim 4, wherein the injection bore plate has two injection bores and, further, wherein the two streams are constituted by the fuel entering radially opposite ends of the first surface and flowing radially inward along the step so that, after the two streams hit against each other, each of the two streams is oriented toward each of the two injection bores.

8. The fuel injection device according to claim 4, wherein a distance between axial centers of the two injection bores is shorter than a distance from the each axial center of the two injection bores to the step.

9. The fuel injection device according to claim 5, wherein the hypothetical line extends substantially perpendicularly to the step.

10. The fuel injection device according to claim 2, wherein the injection bore plate is provided with a plurality pieces of the first surfaces each having two injection bores and with a plurality pieces of the second surfaces, whereby the plurality of first and second surfaces are alternately arranged circumferentially so that the step is formed between each of the plurality of first surfaces and each of the plurality of second surfaces.

11. The fuel injection device according to claim 4, wherein a distance of the first surface in a first radial direction is shorter than a distance of the first surface in a second radial direction perpendicular to the first radial direction, two pieces of second surfaces are formed at opposite end of the first surface in the first radial direction and the first surface has four injection bores.

12. The fuel injection device according to claim 11, wherein a distance between axial centers of the adjacent injection bores is larger than a distance between each axial center of the injection bores and each of the steps adjacent thereto.

13. The fuel injection device according to claim 4, wherein the injection bore plate has a plurality of first surfaces circumferentially arranged so as to abut on one another in a vicinity of an axial center thereof, each of the first surfaces has a single piece of the injection bores and a plurality of second surfaces circumferentially arranged and each being sandwiched between the adjacent two of the first surfaces so that the steps are formed on both sides of each of the first surfaces.

14. The fuel injection device according to claim 13, wherein, in each of the first surfaces, a distance between an axial center of the injection bore and one of the steps is different from a distance between the axial center of the injection bore and the other of the steps.

15. The fuel injection device according to claim 2, further comprising:
a fuel inflow control member disposed in the fuel passage on a side of the valve seat with respect to the injection bore plate for allowing fuel from the fuel passage to flow into the first surface.

16. A fuel injection device comprising:
a valve body having an inner wall in which a fuel passage is formed, the inner wall being provided with a valve seat;
a valve member having a valve coming in contact with the valve seat, the valve member being operative to close the fuel passage when the valve is seated on the valve seat and to open the fuel passage when the valve leaves the valve seat; and
an injection bore member mounted on an end of the valve body downstream the valve seat, the injection bore member being provided in a vicinity of a radial center thereof with a plurality of injection bores and with a guide passage including a step for causing fuel from the fuel passage to flow in at longitudinal opposite ends thereof and to flow along the step toward a center thereof to which inlets of the injection bores are opened.

17. The fuel injection device according to claim 16, wherein the guide passage has a reducing area portion whose area is gradually smaller toward the center thereof and a enlarging area portion which is connected to an end of the reducing area portion on a side of the center thereof and whose area is gradually larger toward the center thereof.

18. The fuel injection device according to claim 16, wherein the injection bore member comprises a plurality of plates stacked on top of each other.

19. The fuel injection device according to claim 16, further comprising:
a guide member disposed between the end of the valve body and the injection bore member for guiding the fuel from the fuel passage toward the longitudinal opposite ends of the guide passage.

20. The fuel injection device according to claim 19, wherein a space is formed between the guide member and the end of the valve body and the guide member is provided with control holes through which the space communicates with the longitudinal opposite ends of the guide passage of the injection bore plate.

21. A fuel injection device comprising:
a valve body having an inner wall in which a fuel passage is formed, the inner wall being provided with a valve seat;
a valve member having a valve coming in contact with the valve seat, the valve member being operative to close the fuel passage when the valve is seated on the valve seat and to open the fuel passage when the valve leaves the valve seat; and
a control member mounted downstream the valve seat, the control member being provided with a plurality of injection bores, with a first surface to which inlets of the injection bores are opened and with a second surface positioned on a side of the valve seat with respect to the first surface so that a step is formed between the first and second surfaces,
wherein, when an axial end of the valve member is in contact with the second surface, the first surface, the axial end of the valve member and the step form a guide passage through which fuel from the fuel passage is flowed into the injection bores.

22. The fuel injection device according to claim 21, wherein the second surface comprises a pair of bow shaped surfaces between which the first surface is sandwiched so that the first surface is sandwiched between a pair of the steps in parallel with each other.

23. The fuel injection device according to claim 1, wherein each inner diameter of the injection bores is substantially uniform in thickness direction thereof.
